(19) United States
(12) Patent Application Publication
(10) Pub. No.: US 2019/0043500 A1
(43) Pub. Date: Feb. 7, 2019

(54) VOICE BASED REALTIME EVENT LOGGING

(71) Applicant: NOWSPORTZ LLC, Clarkston, MI (US)

(72) Inventors: Khalid Mahmood MALIK, Troy, MI (US); Khalid MIRZA, Troy, MI (US); Neil DUEWEKE, Clarkston, MI (US)

(21) Appl. No.: 16/053,290

(22) Filed: Aug. 2, 2018

Related U.S. Application Data
(60) Provisional application No. 62/540,960, filed on Aug. 3, 2017.

(51) Int. Cl. G10L 15/22; G10L 15/18; G06F 17/27; G10L 21/0232; G10L 15/16; A63F 13/215; A63F 13/46; A63F 13/424

(52) U.S. Cl. CPC G10L 15/22; G10L 15/1822; G06F 17/274; G10L 21/0232; G10L 2015/088; G10L 15/1815; A63F 13/215; A63F 13/46; A63F 13/424; G10L 15/16

(57) ABSTRACT

A method for unsupervised automated event detection from multimedia based on parsing an audio stream in real-time. Audio mining techniques are used along with speech recognition software to extract customized keywords that are specific to the application. Machine learning and knowledge-based techniques are used to remove any ambiguity in converted text to achieve high accuracy in keyword detection, and to perform disambiguation of polysemous terms. Knowledge graph and rule based intelligent software generates events by analyzing the stream of keywords. Events are transformed into customized reports based on the application. The system also predicts a personalized future event considering the current and historical domain-specific data along with local (personal) and contextual (ambient) data using an artificial neural network. Events may be video-recorded with a system for automated unsupervised video capture of the events from one or more video streams without manual panning or zooming of a video camera.

### REFERENCE TO RELATED APPLICATIONS

This application claims the benefit of U.S. provisional application Ser. No. 62/540,960 filed Aug. 3, 2017, the disclosure of which is hereby incorporated in its entirety by reference herein.

### TECHNICAL FIELD

This disclosure relates to a system and method of logging data points for an event in real-time based upon a signal from an audio or audio/video source describing the event.

### BACKGROUND

Event detection based on audio and visual cues is a relatively straightforward task for humans. For example, a scorekeeper for a sporting event can record actions including plays, scoring, fouls, penalties, and the like while watching the game as it is being played. As used herein, the term “scorekeeper” refers to a person who keeps score in a game including statistics for the team and the individual players. A scorekeeper can also do the same by just listening to the live audio commentary of the game. On the other hand, developing a software solution for event detection in real time faces many challenges to keep up with the performance of a human scorekeeper in sporting event applications.

This disclosure is directed to solving the above problems and other problems as summarized below.

### SUMMARY

This disclosure details the design of a “High-Accuracy, Voice-Based, Intelligent Event Detection in Real-Time” solution that can be used in a variety of applications. The approach focuses on parsing an audio stream in real-time to extract the keywords that are customized to the application and use intelligent software to semantically analyze the keywords to accurately detect events. The goal is to reliably replace the manual recording of actions in an event with an automated solution. The disclosed approach provides a continuous stream of tagged events and generating media rich reports in real-time on-demand.

The successful implementation of this approach can be broken down in the following three essential parts:

### Real-Time Event Detection

Actions occurring during the event are detected in real-time or with a speed comparable to the reaction time of humans. There are many applications that may benefit from automated event detection. An example of one application is monitoring and recording of actions and game events based upon a live audio commentary of a sporting event. Detecting game events in real-time is used to record and update the scorecard for the game. Detected game events can be associated with live audio/video clips for instantaneous analysis.

### Voice-Based Approach

The voice-based approach utilizes the natural way commands can be issued by a person to trigger or record events. A spoken audio stream is parsed to obtain the necessary keywords for generating events. For example, in a conference room setting, voice commands can be issued by any person in a normal way that can generate events to control equipment or tag the recorded audio/video for immediate or later search in an efficient manner. A factor that can affect the accuracy of speech conversion to text is the audio stream quality degradation due to environmental noise factors. In a sporting event setting, the amount of noise in the audio stream may be actively minimized before any analysis is performed.

### High-Accuracy Intelligent Algorithm

There are several limitations of existing speech recognition software. Accuracy of the speech conversion to text is frequently compromised by issues like clarity and pronunciation of words by the speaker and ambiguity due to like-sounding words. The software approach detailed in this document addresses and corrects for these issues to achieve a highly accurate detection of events from an audio stream. The scope of the uncertainty is managed by detecting a limited number of keywords relevant to the application. The intelligent software accommodates keywords that sound alike and can be further trained to account for accents and varied pronunciation of keywords between different speakers.

According to one aspect of this disclosure, a method is disclosed for automating event data recording. The method comprises monitoring an audio signal and converting the audio signal to a set of text data. The set of text data is then matched to a predetermined set of keywords. Domain specific event analytics are applied to the set of keywords to generate event analyzed data and reports may be generated of the event analyzed data.

According to other aspects of the method, selected words of the set of text data may be tagged to provide a parsed set of text data. The parsed set of text data may be filtered using a general purpose and domain specific ontology or knowledge graph to provide disambiguated keywords, wherein the set of keywords that the domain specific event analytics are applied to are the disambiguated keywords.

The step of monitoring the audio signal may be performed on a live audio feed signal, a recorded audio signal or an audio/video signal. The audio signal may also be prepared by filtering out noisy data. The step of converting the audio signal to a set of text data is performed by using readable text to transmit data objects, wherein a keyword is selected from multiple potential variations of a word based upon an assigned confidence value. The predetermined set of keywords is learned by a database table that is calibrated to accommodate variations in pronunciation of the keywords. The predetermined set of keywords may be parsed for context using natural language processing.

Disambiguated keywords are assembled in a data structure that accumulates the disambiguated keywords into the event analyzed data. The method may further comprise acquiring contextual data including local environmental data from a network. The method may further comprise acquiring contextual data including personalized data from a wearable sensor. In another aspect of this disclosure, the method may further comprise acquiring contextual data for an artificial neural network to predict an individual's performance in sports event, for example.

According to another aspect of this disclosure, a system is disclosed for analyzing an event. The system includes a network, an audio signal source providing a real-time description of the sporting event over the network, a server, and an interactive monitor. The server includes a speech-to-text transcriber that provides a set of text data, a keyword table that identifies keywords in the set of text data and provides a set of filtered text data, and an analytical module acting on the filtered text data calculates domain specific statistics. The interactive monitor has a graphical user interface for controlling the domain specific statistics displayed on the monitor.

According to other aspects of the system, at least one video recorder may provide a video stream of the event to the interactive monitor, wherein the real-time text record is time-tagged to identify and facilitate replaying selected portions of the video stream.

At least one video recorder may be set to capture the entire field of view of the sporting event.

A natural language and knowledge-based processor that semantically parses the set of filtered text data and provides a set of parsed text data.

The system may further comprise a context filter that compares the set of parsed text data to a table of domain specific terms to provide a real-time disambiguated text record of the event to the analytical module.

The above aspects of this disclosure and other aspects will be described below with reference to the attached drawings.

### BRIEF DESCRIPTION OF THE DRAWINGS

FIG. 1 is a system level schematic diagram showing the main inputs to the system and the resulting outputs.

FIG. 2 is a flow chart depicting one embodiment of the processing architecture, key components and flow of the event detection method.

FIG. 3 is a schematic diagram of one embodiment of a client-server based implementation in a sports application.

FIG. 4 is a flowchart depicting processing for an event video stream.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

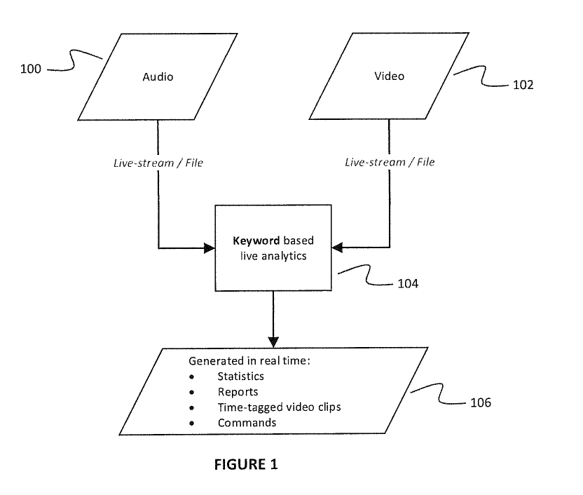

FIG. 1 illustrates the system level concept of one embodiment of a method and system for event detection based on parsing an audio stream for keywords as a schematic diagram. An audio signal 100 is received as a live-stream or from a recorded source. Optionally, a video signal 102 may be provided as a live-stream or from a recorded source. The main processing block 104 analyzes the audio signal 100 in real-time parsing for keywords using Audio Mining and Artificial Intelligence technologies. Keywords are then combined to detect events specific to the application. The continuous stream of generated events is processed to generate real-time reports 106 that can include live statistics, time-tagged video-clips, commands, and the like.

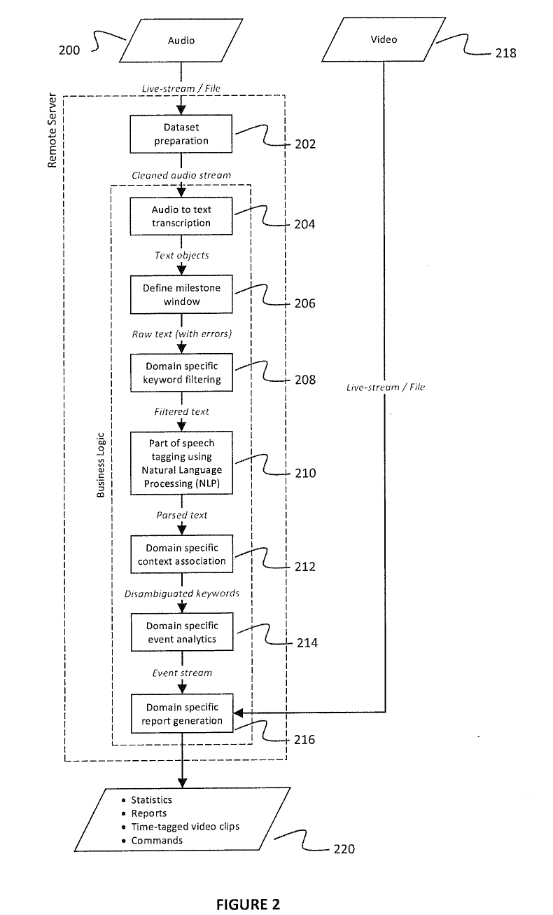

FIG. 2 is a flowchart showing the key components and flow one embodiment.

An audio stream 200 is received as a live-stream or from a recorded source that is sent to a remote server for processing.

Dataset preparation 202 begins by creating a training dataset using input from pronunciation of keywords of specific application by users. For speech calibration purpose, application specific keywords training set in both a sound format and a corresponding text string. Data is preprocessed that includes a) Data cleaning: depending on application, it may include filling in missing values, smoothing noisy data, identifying or removing outliers, and resolving inconsistencies. b) Data integration: using multiple databases, data cubes, or files. c) Data transformation: normalization and aggregation. d) Data reduction: reducing the volume but producing the same or similar analytical results. e) Data discretization: part of data reduction, replacing numerical attributes with nominal ones.

Audio to text transcription 204 is performed at the remote server. Since the input to speech-to-text API should be in audio file format (WAV, FLAC, OPUS), our proposed method extracts audio from input video using FFMPEG library for desktop or native applications. For web based applications web speech APIs (e.g Google Speech APIs or IBM Watson speech API) are employed. The output from this API service is in JSON object format with response object containing text of audio input and confidence value. The output of each milestone is passed to various filters. For identification of a correct word, multiple variations are taken and then selected based on confidence value the one based on highest confidence value and our input from training dataset.

The defined milestone window 206 assures that the transcribed text chunks are properly handled and broken into milestones. The speech recognizer is configured to get ‘n’ number of best results and is put in listening mode. The recognizer remains in listening mode for ‘M’ seconds and the transcribed text from speech is passed to various filters in a separate processing thread. After ‘M’ seconds, in a main processing thread, the recognizer is put into listening mode again using call back function to retrieve text for the next milestone. The milestone window is defined by the total time required to read a segment of video file.

The resulting text is affected by a variety of factors like clarity and pronunciation of words by the speaker, ambiguity due to like-sounding words and external noise issues. This raw text generally cannot be directly used for accurately parsing events. The business logic portion of the application is used to parse the raw text through several stages to break it down to accurately match a limited number of keywords specific to the application. These keywords are then put together to detect and annotate the events.

The next stage is domain specific keyword filtering 208, which uses several techniques to find the best match for the keyword spoken. A domain specific keyword list is maintained for each application. Speech calibration step is performed to train the system if there are variations in pronunciation and clarity of keywords spoken by the user. In case variations are detected, a sound-alike keyword is added to the main list to correctly detect it from the audio stream. A two-level machine learning based method is performed to check and stitch the keywords back in the transcribed text. At the first level, as soon as a new word from audio stream is converted into text, a Gaussian mixture hidden Markov model is used to estimate using Maximum Likelihood Estimation. In second level, Maximum Mutual Information Estimation is employed on training dataset of application specific sounds of keywords to detect the best matched keyword. The result is filtered text that has been corrected as accurately as possible for the possible keywords spoken and can then be parsed for context.

The next stage 210 performs part of speech tagging using Natural Language Processing (NLP). Third party APIs are used, such as General Architecture for Text Engineering or GATE Stanford API. Statistical based and ontology driven NLP is employed to perform analysis, understand and derive useful meaning from the converted text data. The function of the NLP processes is to extract single word and multiword (collocations) tokens from text milestones. A milestone can comprise a sentence, or section of the text that collectively yields a token store that provides sense to the data (depending upon length of ‘M’). The NLP process consists of five stages: i) Tokenization/Sentence Splitting, ii) Part of Speech (PoS) tagging, iii) Stop word removal, iv) Stemming, and v) Name Entity Recognition (NER). A combination of statistical and ontology driven information extraction approaches are used to perform efficient sentence fragmentation and tokenization. Parts of Speech in the Milestone are tagged to respective grammatical sense using statistical methods of Stanford API. Commonly occurring words in the text are removed in the Stop Word Removal stage to allow better concentration on diverse tokens. In Stemming, we remove the differences between changed forms of a word, to identify it in its original root form. Finally, Name Entity Recognition (NER) provides labeling of different words into person, organization, location, things etc. Hence, at the end of five stages of NLP word treatment a token store is obtained that can be used for further contextual sense analysis.

Knowledge-Graph/Ontology Driven context association 212 is determined with in milestone and number of instances involved. For example, using triplet notation (subject, verb and object), the number of fouls against each player in application relevant to sports can be determined. To identify semantic relevance of identified keywords based on content and context, various application specific rules and Ontology driven information extraction are employed.

After maintaining a token store (collection of tokens), for each token in a milestone, a query is made against candidate ontology (e.g. general-purpose ontology like Freebase, DBpedia, YAGO2s from Linked Open Data) or prepared Domain (application) specific ontology to gather more detailed semantics of each token. For example, in sports application, if commentator says, “Benjamin has scored a goal” and later on narrates “As mentioned in his interview that Benjamin's goal for this season is to become top scorer and he has achieved that goal”. Here the “goal” in the first sentence should be treated as a score event while that in the second sentence should be ignored. Another such example is “foul” in the game. In a nutshell, the part of speech is first correctly defined (for example, whether foul was used as adjective, noun, verb or adverb) and is then disambiguated further to identify correct sense.

One task is to determine whether there is any polysemous word in the milestone. To find out whether any noun or name entity is ambiguous, a general purpose knowledge graph (ontology) such as the DBpedia, YAGO, or Google Knowledge Graph or domain specific knowledge graph (ontology) could be used. For example, DBpedia relation′wikiPageDisambiguates′ could be used for the term to acquire Uniform Resource Identifier (URI). If the URI is ambiguous, multiple resource URIs are obtained. Similarly, for verb disambiguation, the total number of senses returned against polysemous token are accessed to resolve any ambiguity in the disambiguation phase. If multiple senses are returned, the verb is polysemous.

The milestone can yield ‘N’ number of tokens in which ‘i’ number of tokens have single sense (monosemous) and “j” number of tokens have multiple senses (polysemous) as mapped by knowledge-based resources such as WordNet/DBpedia. Based on the senses or meanings obtained for different tokens, the best sense match is determined. In the next step of Disambiguation process, META-tokens for each of the monosemous tokens are extracted from Abstract and Infobox sections of the data (Token's Topic) using ontology or knowledge graph (e.g. DBpedia) enrichment. This in turn provides the “Context” of data which is a collection of monosemous tokens and META-tokens. Each of the polysemous tokens as mentioned above have multiple senses and each sense can further have multiple tokens. The sense of each token is compared with context entries using LESK similarity approach that will assign a score for each comparison. Summation of all comparison results for a specific polysemous token sense, provides us the Similarity Score for that sense. The Polysemous token is assigned the sense with the highest Similarity Score. The number of tokens for each sense in a Polysemous token may vary. Hence, normalization is used to obtain the optimal number of tokens to be considered per sense for simpler and efficient disambiguation.

After word sense disambiguation, semantic enrichment (e.g. acquiring synonyms or alternative label) is performed of both given set of domain specific keywords and all parsed disambiguated terms/concepts/tokens from audio. After performing semantic matching, using domain-specific or general-purpose ontology, between semantic enrich keywords with semantic enriched tokens in context, the video resource is annotated along with time-stamp. Next, event analysis 214 is then performed. Based on the domain specific rules the sequence of keywords is transformed into an event. Application specific events are taken as input to the system. Various data structures are implemented to facilitate the analytics. For example, to collect the statistics of each player, a number of objects are defined to track various events. Each event is incrementally counted as soon as it is detected during the analysis of speech to text. For example, number of fouls are incremented against each player as soon as a foul is detected using our triplet notation model. The result is a real-time continuous stream of detected events that can then be tailored into reports in the desired form.

The proposed system may be used to predict a future event (e.g. performance of player) considering the current and historical game data along with contextual data using an Artificial Neural Network (ANN). A contextualized prediction, depending upon the event, will be either a binary classification or a multilabel classification.

Once the system executes an ontology-based information extraction on text data (after voice to text conversion) to acquire domain specific events, the system acquires contextual data. The contextual data may consist of personal and ambient data obtained through one or more sensors or from a network, such as the Internet. Next, principal component analysis is applied on both domain specific and ambient data to select the important features. These selected features are fed to an input layer of the artificial neural network for classification with one or more classes being predicted.

For example, the contextualized prediction can assist a coach in soccer game to choose players for last 15 minutes in certain game by predicting each player performance as being classified in one of the classes: Best, Good, Neutral, Below Average. The features for prediction will be domain specific (e.g. soccer) as well as event specific (selection of penalty kick/shooter or selection of 11 best player in last 10 minutes of game). The possible game-specific data points relevant to player's current and historical game-specific performance indicators in certain specific conditions or locations, the performance of opposing team players, current contextual data points (the local environmental features such as temperature, humidity, air direction, tiredness level measured using sleep quality, pressure of crowd). Local environmental features may be extracted from web sources such as weatherforyou.com and personalized data can be collected from wearable sensors.

Step 216 in the business logic is to generate domain specific reports. Following the rules for the specific application, the events are recorded into reports as needed by the application. Additional real-time information, such as video 218 is also provided as a live-stream or from any other recorded source and can be incorporated in the reports.

The event reports 220 can be presented in a variety of forms such as statistics (sporting event scorecards), reports (documentation of sequence of events), time-tagged video clips (triggered by specific events), commands (to activate and control external processes), etc.

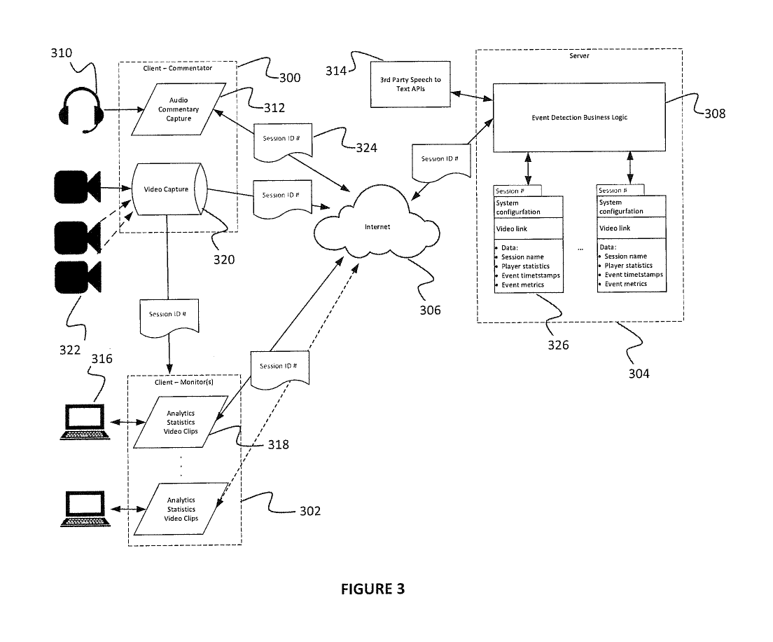

FIG. 3 shows a system setup of an example of one embodiment in the sports application. The client-server based implementation depicts a full implementation of the voice-based event detection system to generate real-time game analytics. The client side has a commentator 300 and one or more monitors 302. They are connected to the application server 304 through an internet 306 connection. During the game, the live audio commentary is provided by the commentator client and sent to the server for event detection. The generated game analytics are made available to monitor client(s) in real-time and can be used to keep and update the game scorecard and generate instant video replay clips on demand that are tagged to the game events.

The client application 300 can be realized on a tablet, laptop or a computer. The application is connected to Internet to reach the event detection business logic 308 on the server. A noise cancelling microphone 310 is used to capture the live audio commentary 312 to provide a noise free audio stream to third party speech to text APIs 314 on the server side.

The monitor application 302 can be provided utilizing a tablet, laptop or a computer. The application is connected to Internet to reach the event detection business logic 308 on the server. Multiple monitors 316 can access the real-time detected event information from the server in the form of a customized report template 318 for the particular application. Each monitor can individually display the event information in the form desired. For example, the game score-keeper can display the information in the form of a live score-card that is updated in real-time. A coach can look at the sorted events based on players, scores, fouls, etc. and have access to all tagged events in the game for instant review or half-time analysis.

Video capture 320 can also be implemented on the client side. Video cameras 322 can be used to record one or more streams of video in the desired quality. A live video stream is sent to the server with modulated quality based on the available internet connection bandwidth. A high quality video stream can be locally recorded and can be used to generate full resolution tagged video clips. With video available, the monitor application can have links available to video clips tagged to various events in the game for instant access and review.

To implement security for handling multiple simultaneous clients, a password based login mechanism is provided on the server side. At the event, the commentator client creates a session ID 324 when logging in. This session ID is then used to keep track of all event information at that particular game. All incoming audio and video streams and any other associated data is kept with the session ID in a data structure 326 for real-time access of information, and for storage of game events and their retrieval at a later time.

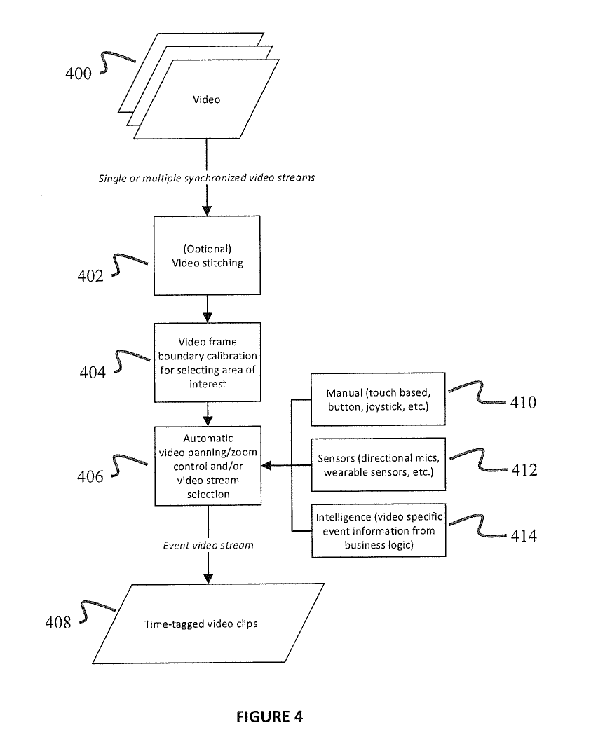

FIG. 4 is a flowchart showing one embodiment of the key components and flow for generating event video stream. This method is utilized to facilitate automated unsupervised video capture of events that otherwise would require manual panning/zooming of the camera and/or manual selection of one video stream from several available video streams. The entire field of view of the event may be captured by either using video streams 400 from a wide-angle view camera or multiple cameras.

Based on the application needs, the synchronized multiple video streams can be stitched together 402 in real-time to provide a combined video stream covering a larger portion of the event.

Before start of the event, setup can be performed to calibrate the video frame boundaries for the event. Each available video stream can go through video frame boundary calibration 404 to select an area of interest within the entire video frame. Inside the selected area panning, zooming and/or selection can be performed.

The available and bounded video streams are then provided to the automatic video panning/zooming/selection module 406 to facilitate production of a single video stream for the event that can be used for generating time-tagged video clips 408. The automatic video control module 406 can derive information to control the panning, zooming and/or selection between multiple video streams using a variety of inputs with additional internal video processing. The simplest method utilizes manual techniques where a user can select or pan/zoom within bounded regions of the video triggered by touch-based input, buttons or joysticks 410. For example, a live video stream of a soccer field shown in a window on a tablet can be easily panned from one goal side to the other by swiping the finger left or right on the screen.

Sensors 412 can also be used to generate automatic video panning/zoom/selection control. These can include directional microphones, wearable sensors, and the like. For example, a directional microphone calibrated with multiple video cameras can be placed in the middle of a conference room setup to automatically select the proper video stream and/or zoom based on the person talking.

Intelligent control schemes 414 can be added to the module to work in combination with the other methods described. In one embodiment of the method video control information can be derived from intelligent analysis of real-time event stream 214 (shown in FIG. 2) to predict the probable positional location of the event within the calibrated video frame boundaries. Based on the type of event, video control information can be further enhanced by real-time video stream analysis to detect descriptors, such as motion, to confirm positional location of the event within the video frame. For example, a single wide-angle view video stream covering the entire basketball court can be automatically panned or two separate video streams covering the two halves of the court can be automatically selected to follow the action during the game.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

We claim:

1. A method of providing event data recording comprising:
monitoring an audio signal;
converting the audio signal to a part of speech converted to text data;
matching the text data to a predetermined set of keywords;
applying domain specific event analytics to the set of keywords to generate event analyzed data; and
generating a report of the event analyzed data.

2. The method of claim 1 further comprising:
tagging part of speech to converted text data to provide a parsed data tree.

3. The method of claim 2 further comprising:
filtering the parsed data tree using a domain specific context association knowledge graph to provide disambiguated keywords, wherein the set of keywords that the domain specific event analytics are applied to are the disambiguated keywords.

4. The method of claim 1 wherein the step of monitoring the audio signal is performed on an audio signal selected from the group consisting of:
a live audio feed signal;
a recorded audio signal; and
an audio/video signal.

5. The method of claim 1 further comprising:
preparing the audio signal by filtering out noisy data.

6. The method of claim 1 wherein the step of converting the audio signal to a part of speech converted to text data is performed by using readable text to transmit data objects, wherein a keyword is selected from multiple potential variations of a word by an assigned confidence value.

7. The method of claim 1 wherein the predetermined set of keywords is learned by a training dataset that is calibrated to accommodate variations in pronunciation of the keywords.

8. The method of claim 1 wherein the predetermined set of keywords is parsed for context using natural language processing.

9. The method of claim 1 wherein the disambiguated keywords are assembled in a data structure that accumulates the disambiguated keywords into the event analyzed data.

10. The method of claim 1 further comprising:
acquiring contextual data including local environmental data from a network.

11. The method of claim 1 further comprising:
acquiring contextual data including personalized data from a wearable sensor.

12. The method of claim 1 further comprising:
acquiring contextual data for an artificial neural network to predict a player's performance.

13. A system for analyzing an event comprising:
a network;
an audio signal source providing a real-time description of the event over the network;
a server including
a speech-to-text transcriber that provides a set of text data,
a keyword table that identifies keywords in the set of text data and provides a set of filtered text data,
an analytical module acting on the filtered text data calculates domain specific statistics; and
an interactive monitor having a graphical user interface for controlling the domain specific statistics displayed on the monitor.

14. The system of claim 13 further comprising:
at least one video recorder providing a video stream of the event to the interactive monitor, wherein the real-time text record is time-tagged to identify and facilitate replaying selected portions of the video stream.

15. The system of claim 14 wherein at least one video recorder captures the entire field of view of the event to facilitate unsupervised panning/zoom of video frame.

16. The system of claim 13 further comprising:
a natural language and knowledge-based processor that semantically parses the set of filtered text data and provides a set of parsed text data.

17. The system of claim 16 further comprising:
a context filter that compares the set of parsed text data to a table of domain specific terms to provide a real-time disambiguated text record of the event to the analytical module.
